(19) United States
(12) Patent Application Publication
(10) Pub. No.: US 2015/0131477 A1
(43) Pub. Date: May 14, 2015

(54) Method for activating deactivated controllers of a vehicle, a vehicle network and also nodes of the vehicle network

(71) Applicant: CONTINENTAL AUTOMOTIVE GMBH, Hannover (DE)

(72) Inventors: Norbert Balbierer, Kelheim (JP); Josef Nöbauer, Neukirchen-Balbini (GB)

(21) Appl. No.: 14/400,451

(22) PCT Filed: May 7, 2013
(86) PCT No.: PCT/EP2013/059532

§ 371 Date: Nov. 11, 2014

(30) Foreign Application Priority Data
May 11, 2012 (DE) 10 2012 207 858.4

(51) Int. Cl. H04L 29/08

(52) U.S. Cl. CPC H04L 67/125
USPC 370/254

(57) ABSTRACT

In a vehicle network in which controllers of the vehicle form nodes communicating with one another, wherein a group of the controllers to be activated is combined in a subnetwork to be activated, wherein each node has at least one network interface to an adjacent node directly addressable via the network interface, and a subnetwork manager indicating which network interface a node can use to communicate with which subnetwork, a method activating deactivated controllers includes: upon receipt of an activation command by the controllers of a subnetwork, a node identifying in the subnetwork manager which network interfaces the subnetwork manager can use to communicate with the subnetwork to be activated; the node using the identified network interfaces to transmit the activation command to adjacent nodes; and upon the transmission of the activation command, activating an adjacent node if the adjacent node was deactivated prior to transmission of the activation command.

### CROSS-REFERENCE TO RELATED APPLICATIONS

This is a U.S. national stage of application No. PCT/EP2013/059532, filed on 7 May 2013, which claims priority to the German Application No. DE 10 2012 207 858.4 filed 11 May 2012, the content of both incorporated herein by reference.

### BACKGROUND OF THE INVENTION

1. Field of the Invention

The invention relates to a method for activating deactivated controllers of a vehicle, particularly a motor vehicle, in at least one, preferably wired, particularly Ethernet-based, vehicle network, in which the controllers of the vehicle that form the nodes of the vehicle network can communicate with one another using at least one network protocol, particularly the Ethernet protocol. In this case, it is possible to combine a selected group to be activated comprising controllers of the vehicle that are in a communication relationship with one another to form a subnetwork to be activated in the overall vehicle network.

The invention also relates to a node of a vehicle network, which node is set up to carry out the method, and to the vehicle network formed from a plurality of correspondingly set-up nodes.

2. Related Art

Besides the typical bus systems in the automotive field, for example a CAN bus, a MOST bus, a FlexRay bus or a LIN bus, the Ethernet known from Internet applications is also increasingly finding its way into automotive or vehicle engineering. The Ethernet network has a high dedicated data rate, is highly flexible and has worldwide standardization. Therefore, Ethernet is suitable as an important system interface within the vehicle and is increasingly also used as such.

The increasing electrification of vehicles means that the power requirement thereof is also increasingly rising, however. This in turn results—in the case of conventional vehicles—in increased fuel consumption, which has a direct impact on the end user (vehicle owner) in terms of cost. In addition, taxation on motor vehicles today is calculated from CO₂ (carbon dioxide) emissions, these being derived from energy consumption (fuel consumption of petrol or diesel).

Particularly in the case of electrically operated vehicles, on the other hand, the range is directly dependent on the capacity of the battery and the power requirement of the loads supplied by the battery, which means that a high power requirement decreases the range of an electrically operated vehicle. Although this is also the case, in principle, for an internal combustion engine, because the alternator is under higher loading in the event of a high power requirement and this results in higher fuel consumption and associated shorter range, the short ranges—that can be achieved with the storage battery capacities to date—of approximately 100 km in the case of an electrically operated vehicle, in conjunction with the long idle times when recharging the storage batteries, have a more significant effect.

One way of saving energy is to switch on only those controls of the vehicle that are needed in the respective situation or in the respective vehicle state. This is called subnetwork operation, in which a group of controllers of the vehicle that are in a communication relationship with one another is combined to form an active subnetwork or a subnetwork to be activated. In order to realize such a subnetwork operation, controllers need to be activated, i.e., woken from a standby mode or switched on. The information concerning which controllers are needed in the network needs to be coordinated, so that in previous applications a central entity would need to perform the activation (wakeup process) of the controllers as needed.

In the vehicle networks employed in series in the automotive field today, which are based on the bus systems CAN, FlexRay, MOST or LIN, there is not yet a subnetwork operation. In that case, all the subscribers, which also include the controllers, wake simultaneously, either under the control of the ignition of the vehicle or as a result of activity on the vehicle bus, i.e., in the vehicle network.

DE 10 2010 008 818 A1 proposes a method for activating a network component of a vehicle network system for Ethernet-based vehicle networks that is accordingly based on a central network manager. For this, the information concerning which controller is at which location at which network address in the network, and in which case this controller needs to be woken, is managed centrally, so that an activation or wakeup process is executed by the central entity as needed. This is complex to manage, however, and results in increased energy consumption for the network manager.

The document “Specification of Communication Manager”, version 2.2.0, AUTOSAR (Automotive Open System Architecture, release 3.2) specifies a mechanism for implementing subnetwork operation in a vehicle network. This is based on the cyclic sending of a network management message on the vehicle bus, which message uses a bit field to indicate which subnetworks of the connected network subscribers (controllers) need to be active. The bus transceivers of all the subscribers are therefore always active and capable of evaluating these messages. When a subnetwork is indicated as active in the network management message, the receiving bus transceiver wakes the rest of the controller, a subnetwork being understood to mean a group of signals or messages that are received or sent by controllers associated with this group. This method is standardized for bus systems today in the automotive sector, but cannot be performed with Ethernet standards for Ethernet protocols in this way.

WO 2003/061175 A2 describes a hierarchically structured radio network having a plurality of cluster heads for organizing the network, single network nodes being able to communicate with the cluster heads on a first frequency. In addition, there is provision for direct communication between the cluster heads on another, second frequency. The effect achieved by the provision of various cluster heads having an organization function is that failure of a central base does not result in complete failure of the radio network. Specific addressing of subnetworks is not possible, however. Furthermore, a proprietary network protocol is used.

US 2011/0138044 A1 discloses a wake-on-LAN (WOL) technology for local area networks (LAN), in which individual subscriber devices in the network can be switched on by special network packets. To this end, the network port of an otherwise switched-off subscriber device remains activated, with the network port switching on the subscriber device following the reception of an appropriate wakeup data packet. If a multiple network port simultaneously connects a plurality of subscriber devices to the network, it is proposed that the wakeup data packet contain an MAC address (media access control address) that is associated with precisely one of the subscriber devices managed by the multiple network port. The multiple network port internally manages the MAC addresses of the subscriber devices connected via a separate port, so that individual subscriber devices or a group of subscriber devices can be switched on selectively.

However, this is a hierarchic network structure insofar as addressing and, if need be, switching on individual subscriber devices requires the multiple network port as a central controller. If this multiple network port fails, it is not possible to access these subscriber devices.

The previous systems for subnetwork management are thus comparatively complex to realize and require significant additional power consumption for energy management.

### SUMMARY OF THE INVENTION

It is therefore an object of the present invention to achieve an energy-efficient way of realizing subnetwork operation in a vehicle network.

This object may be achieved by a method having provision, in particular, for each node, i.e., each subscriber connected to the vehicle network as a communication unit, to have at least one network interface to an adjacent node that is directly addressable by this network interface, and a subnetwork manager that indicates which of the possible plurality of network interfaces the node of the vehicle network can use to communicate with which subnetwork. Hence, each controller that can be connected to the vehicle network forms a node of the vehicle network, without the nodes necessarily being limited to such controllers.

According to an aspect of the invention, when there is an activation command for the controllers of a prescribed subnetwork (whether there is a node initiating the activation of the subnetwork or as a controller initiating the activation of the subnetwork or following reception of an activation command for the subnetwork to be activated), a node identifies in its subnetwork manager which of its network interfaces the node can use to communicate with the subnetwork to be activated, the node then using the identified network interface(s) to transmit the activation command to the adjacent node(s), i.e., the nodes connected directly to the nodes, and the transmission of the activation command activating the adjacent node if the node was deactivated prior to the sending of the activation command, which is a wakeup mechanism in the general form, i.e., the adjacent node is woken from the sleep state if need be.

Since each controller participating in the communication via the vehicle network is also a node of the vehicle network, all the controllers of the subnetwork to be activated are thus gradually activated without the need for a central network manager to be provided. In addition, the nodes of the vehicle network that are needed for the communication of the controllers to be activated in the subnetwork are activated, even if they are not controllers associated with the subnetwork to be activated, but rather are merely required for switching the communication for the controllers of the subnetwork in the vehicle network.

For this purpose, the subnetwork of the vehicle network is understood to mean a group of controllers connected to the vehicle network that are in a communication relationship with one another. Hence, the invention proposes a local method for activating subnetworks in a vehicle network that is at least to some extent also Ethernet-based and for activating the corresponding controllers associated with the subnetwork. To this end, each node in the vehicle network, i.e., each network subscriber involved in the communication of the vehicle network, has a subnetwork manager, also called an energy manager (EM), that manages the subnetworks and subnetwork interfaces of its own node and leaves the network (vehicle network) to communicate with the subnetwork managers (energy managers) of the other nodes. This local management means that none of the nodes needs to know about the overall topology of the vehicle network, but rather merely needs to know about which of the available subnetworks it can reach via which network interfaces and of which subnetwork it itself is part. This can be input as a parameter file at each network node, for example.

Since the invention relates particularly to wired vehicle networks for the vehicle networks, known wakeup mechanisms for wired networks can easily be used to wake the respective adjacent node connected directly adjacently to a node. The mechanisms for this, for example the transmission of wakeup pulses, are known and therefore do not need to be described in more detail. The same naturally also applies for radio vehicle networks, in which, among adjacent nodes, particularly nodes that are in direct radio range of a node are sent.

The local property of the proposed method means that any node, or any controller, can initiate the activation process (wakeup process) for a subnetwork.

According to a particularly preferred embodiment of the method proposed according to the invention, provision may be made for a node receiving an activation command for the controllers of a subnetwork to identify in its subnetwork manager which of its possibly multiple network interfaces it can use to communicate with the subnetwork to be activated, and for the node then to use the identified network interfaces to transmit the activation command to the adjacent nodes of the vehicle network. In this way, the activation command propagates from the controller or node initiating the activation through the entire vehicle network (network) until all the nodes and controllers required for communication in the subnetwork have been activated. This local process also has the advantage that possibly different networks having different network protocols may be connected to one another via gateways, the gateways needing to translate the control commands from one network protocol to the other network protocol.

The method according to an aspect of the invention thus involves the initiating node, or the initiating controller in the case of a subnetwork, to be activated first of all activating or waking all the adjacent nodes that are (directly or immediately) connected to network interfaces (one or multiple) of the nodes that are able to be used to reach the subnetwork to be activated. Next, a wakeup request is forwarded to each of these adjacent nodes. Each of these adjacent nodes in turn has the same, previously described process taking place on it, as if the wakeup request were coming from it itself. As a result, the wakeup process propagates recursively through the network until all the members of the subnetwork have been activated, without the need for a central network manager to be provided.

According to a preferred form, provision may be made for the subnetwork manager of a node to control the supply of power to the node. Hence, the subnetwork manager of the node can, in the event of an activation command being present, activate and switch on the entire node or the controller without the need for an additional wakeup mechanism to be installed. A specific option for activation, i.e., waking, is a hardware module that establishes the presence of energy on the line and then activates the energy supply for the rest of the node (controller). By way of example, such a hardware module may be part of the subnetwork manager.

According to an aspect of the invention, provision may also be made for the subnetwork manager of a node to communicate with the subnetwork manager of other nodes of the network, for example in order to change or reinstall subnetworks and/or to implement quality monitoring for the network connection.

As part of the method according to the invention, provision may also be made for a node, for example the subnetwork manager of a node, to be able to use a wakeup command, which may possibly be identical to the activation command for controllers of a subnetwork, to activate adjacent nodes when they are deactivated. The mechanisms provided for this purpose are basically known for wired or wireless communication networks. The advantage of the application when activating subnetworks is that it is possible to achieve a very effective possibility of local management of the subnetworks and of the subscribers of the subnetworks, and the subscribers that are not needed can be deactivated completely if they are not used.

The local subnetwork management according to the method proposed according to the invention also allows a node, preferably each node formed by a controller, to initiate an activation command for activating a subnetwork if this controller or this node has the need to communicate in this subnetwork. Besides particularly energy-efficient management of the subnetworks, this also allows particularly fast activation of a subnetwork to be achieved, since any node (controller) establishing the need for such a subnetwork can begin activation of the subnetwork immediately.

According to a particularly preferred method variant, provision is made for the communication in the network to be effected (at least to some extent) as Ethernet-based communication, i.e., to take place using an Ethernet network protocol (transport protocol). This allows the advantages and flexibility of Ethernet communication to be used easily in vehicle networks too.

In addition, the invention may provide for a node in the form of a gateway to set up switching between subnetworks with a different network structure, particularly switching between a subnetwork with Ethernet-based communication and a subnetwork with CAN-bus-based communication, without the invention being limited to precisely these combinations of different subnetworks. The local, nonhierarchic management of the subnetwork activation in accordance with the invention is therefore particularly flexible.

Correspondingly, an aspect of the invention also relates to a node in a preferably wired, particularly Ethernet-based, vehicle network having at least one network interface and a subnetwork manager, which is also called an energy manager for the node, having a computation unit. The node can particularly form a controller of the vehicle network, but may also be in the form of a controller without additional functions, for example just in the form of a relay station or gateway. The invention provides for the computation unit to be set up to carry out the previously described method or portions thereof.

Correspondingly, an aspect of the invention relates to a vehicle network having a plurality of nodes that are interconnected via network interfaces to form the preferably wired, particularly Ethernet-based, vehicle network. According to the invention, the nodes forming the vehicle network are set up in line with the previously described nodes for carrying out the previously described method or portions thereof.

According to an aspect of the invention, the nodes are set up by program code for execution on a computation unit that are designed such that they execute the proposed method when they are executed on the computation unit. The program code is preferably stored in a non-transitory computer readable medium.

### BRIEF DESCRIPTION OF THE DRAWING

Further advantages, features and opportunities for application of the present invention will emerge from the description below of exemplary embodiments and from the drawing.

In this case, all the described and/or graphically presented features separately or in any combination form the subject matter of the present invention, even regardless of their combination in the claims and the back-references thereof. In the drawing:

FIG. 1 shows a preferred embodiment of a vehicle network with network nodes that are set up to carry out the method according to the invention for activating deactivated controllers.

### DETAILED DESCRIPTION OF THE PRESENTLY PREFERRED EMBODIMENTS

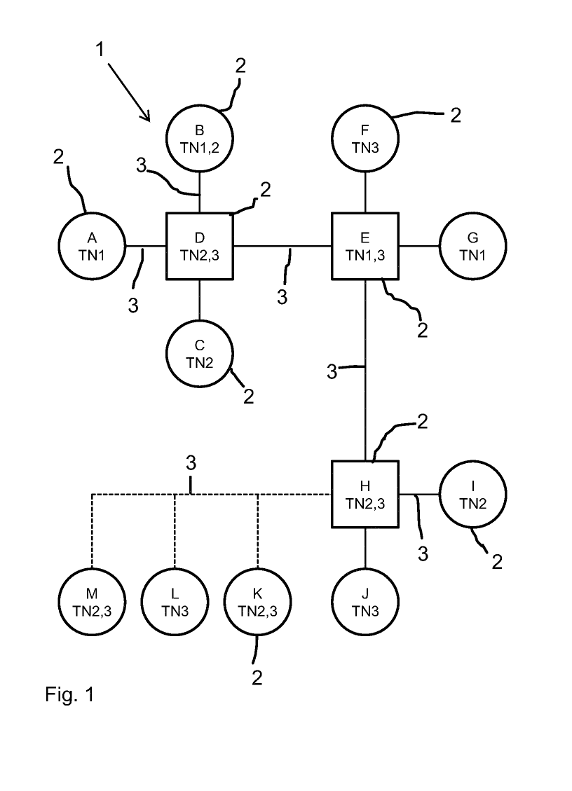

The vehicle network 1 shown in FIG. 1 thus has nodes 2 that are presented as circles or squares, not all the nodes being provided with the reference symbol 2 for the sake of clarity. The nodes 2 presented as circles each have just one network interface. The nodes 2 presented as squares have a plurality of network interfaces. The network interfaces connect the nodes 2 to one another via a wired network by communication lines 3. The communication lines 3 are also called bus lines of the vehicle network 1. In this case too, not all communication lines 3 are provided with reference symbols for the sake of clarity.

A node 2 is particularly in the form of a controller or gateway and is denoted by letters A to M in the drawing for the purpose of identification. In addition, each node contains a subnetwork number TN1 to TN3, which indicates which controller A to M belongs to which subnetwork TN1 to TN3. All the controllers A to M (or nodes 2) that are part of a subnetwork TN1 to TN3 are in a communication relationship with one another and therefore need to be activated in the case of a subnetwork TN1 to TN3 to be activated, wherein, in addition to the nodes 2 to be activated that are part of a subnetwork TN1 to TN3, it is also necessary to activate the nodes 2 that form only a communication interface for the nodes 2 of a subnetwork TN1 to TN3.

To this end, each node 2 has a subnetwork manager, particularly implemented in its computation unit, that is not shown in the drawing and that indicates which network interface the node 2 of the vehicle network 1 can use to communicate with which node 2 of which subnetwork TN1 to TN3.

In the case of the node D, the subnetwork manager thus indicates that the controller D (node) can use its network interfaces to the controllers A, B and E to communicate with nodes 2 of the subnetwork TN1. Accordingly, the subnetwork manager of the controller D indicates that the latter can use the network interfaces to the controllers B, C and E to communicate with the subnetwork TN2 (i.e., the nodes or controllers 2 of this subnetwork), the controller E as node 2 itself not being part of the subnetwork TN2 but switching communication to the controller H, for example. In addition, the node D itself is also part of the subnetwork TN3, and it can use the network interface to the node E to communicate with this subnetwork TN3. This is also recorded in the subnetwork manager.

In the example shown, the controllers A to J each form nodes (2) of an Ethernet network and the controllers H, K, L, M each form nodes (2) of a CAN bus network. In this case, the controller H (node 2) is a gateway that connects the two network technologies Ethernet and CAN bus to one another.

The description below is for performance of the method for activating deactivated controllers A to M of the vehicle network 1 by way of example for the case in which the controller A wishes to activate the subnetwork TN1.

The controller A can reach the subnetwork TN1 via its single network interface and therefore uses this network interface to wake the node 2 connected thereto, i.e., the controller D. To this end, it uses the communication line 3 to output a control pulse, for example, that activates the controller D via its network interface or the subnetwork manager containing the energy manager, even if the controller D was deactivated at the instant of reception of the activation pulse. In principle, instead of a control pulse, a suitable wakeup mechanism is naturally a possibility, which the controller A uses to activate the node (controller D) connected to the communication line 3.

Even if the controller D itself is not part of the subnetwork TN1, it needs to be activated in order to allow the controller A to communicate with other controllers 2 in the subnetwork TN1.

Following the activation, i.e., the transmission of the wakeup command, for example as the control pulse, the controller A forwards the activation command for activating the subnetwork TN1 to the controller. This can possibly also be effected in combination with the wakeup command.

The controller D or the subnetwork manager thereof recognizes that it can reach the subnetwork TN1 via two of its four network interfaces, namely the network interfaces to the controller B and the controller E. Therefore, the controller D forwards a wakeup command or an activation command containing the wakeup command to each of the controllers B and E.

The node 2 forming the controller B has only one network interface via which it has been activated or has been addressed by the controller D. Hence, the controller B is active and knows that its subnetwork TN1 has been requested. This node B therefore has nothing further to occasion.

In the case of the controller E (node 2), the behavior is similar. This controller knows that only the controller G is still part of the subnetwork TN1 via one of its network interfaces. Therefore, a wakeup command is sent only to the controller G. After the controller G has been woken, the controller D forwards the activation command for the subnetwork TN1 to the controller G, which behaves in precisely the same way as the controller B. Alternatively, it is always possible for the wakeup command and the activation command to be combined in one command.

Hence, all the controllers A, B, E and G, which are part of the subnetwork TN1, and the controller D that is required for communication switching as node 2 have now been activated, which means that these controllers 2 can communicate with one another. The method according to the invention for activating the controllers 2 of the subnetwork TN1 is therefore concluded.

A further exemplary embodiment of the activation method according to the invention shows how the activation also works across network technologies, i.e., even when different network techniques are used in the vehicle network, with a node 2, in the example in FIG. 1 the controller H, functioning as a gateway that connects an Ethernet-based network and a CAN-bus-based network to one another across network technologies.

In this example, which is also explained with reference to FIG. 1, the controller B requests activation of the subnetwork TN2. Before the controller H, serving as node 2, is reached in its function as a gateway, the method proceeds in a manner similar to the previously described method in relation to the activation of the subnetwork TN1, which means that it is possible to dispense with a detailed description in this regard.

The controller B thus activates the controller D, which then activates the controllers C and E. The controller E is activated because the controller D forming a node 2 is aware in its subnetwork manager that the network interface to the controller E, which is not part of the subnetwork TN2 itself, can be used to address further controllers H, I, K and M of the subnetwork TN2.

The controller E forwards a wakeup and activation command to the controller H. In a manner similar to the previous process, the controller E activates its network interface to the controller I, which is part of the subnetwork TN2, in order to forward a wakeup command and an activation command or a combined wakeup and activation command to the controller I forming a node 2. Now, all the controllers B, D, C, H and I of that network portion of the vehicle network 1 that operates on the basis of the Ethernet protocol have been activated.

The controller H, operating as a gateway, now converts the activation command from the Ethernet-related portion of the vehicle network 1 for a wakeup mechanism that is inherent to the CAN-bus-based network, in the case of which the bus transceiver recognizes a requested subnetwork and then wakes the rest of the node. Hence, the known wakeup mechanism inherent to the CAN bus is also used to wake the remaining controllers K and M. This means that all the controllers B, D, C, H, I, K and M that are part of the network TN2 and the controller E are activated for communication switching, as a result of which communication by the subnetwork TN2 can take place and the latter is completely active. The method for waking controllers in the subnetwork TN2 is therefore concluded.

The method according to the invention is therefore a completely distributed, nonhierachic concept, which means that the management as a whole is simple. There are therefore no individual, crucial entities that, if they were to fail, would result in failure of the communication system as a whole, particularly so long as diversion communication paths are possible, even if these are not shown in the simple example network according to FIG. 1.

This increases the security of the system. At the same time, the complexity is distributed over all the nodes 2 or controllers A to M. The activation command or the wakeup and activation command navigates itself through the network 1 without the need for central control to be provided for this purpose. There is thus a proposed way of implementing distributed network management for realizing subnetwork operation in the case of Ethernet-based vehicle networks or Ethernet-based vehicle networks in combination with further bus systems that are used in the automotive field.

The method proposed according to the disclosed embodiments of the invention also produces network communication only during the activation process of a subnetwork TN1 to TN3. No cyclic messages are necessary. In addition, the possibility of waking direct neighbors using suitable wakeup mechanisms that are known per se means that it is not necessary for the network interfaces of disconnected nodes to remain active in order to evaluate network management messages. Controllers 2 that are not needed can therefore be completely disconnected without consuming quiescent current, since they can be woken in any case by a wakeup pulse from an immediately adjacent node 2.

The method according to the disclosed embodiments of the invention can also be combined with the concepts standardized by AUTOSAR for vehicle bus systems that are already used today, which means that network-wide coverage of the subnetwork operation is obtained in an architecture that uses Ethernet-based and classical bus systems together. In addition, it can be applied directly to today's bus systems even when suitable controller-selective wakeup mechanisms are existent.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A method for activating deactivated controllers of a vehicle in a vehicle network (1) in which controllers (2) of the vehicle form nodes of the vehicle network and are configured to communicate with one another, wherein a group of the controllers (2) to be activated in a communication relationship with one another is combined in a subnetwork to be activated, wherein each node (2) has at least one network interface to an adjacent node (2) that is directly addressable via the network interface, and a subnetwork manager that indicates which network interface a particular node (2) of the vehicle network can use to communicate with which subnetwork, the method comprising:
upon receipt of an activation command by the controllers of a subnetwork, a node (2) identifying in the subnetwork manager which of its network interfaces the subnetwork manager can use to communicate with the subnetwork to be activated;
the node (2) using the identified network interfaces to transmit the activation command to adjacent nodes (2); and
upon the transmission of the activation command, activating an adjacent node (2) if the adjacent node (2) was deactivated prior to transmission of the activation command.

12. The method as claimed in claim 11, further comprising:
that activated adjacent node (2) that received the activation command identifying in the subnetwork manager which of its network interfaces the activated adjacent node (2) can use to communicate with the subnetwork to be activated; and
the activated adjacent node (2) then using the identified network interfaces to transmit the activation command to the adjacent nodes (2).

13. The method as claimed in claim 12, wherein the subnetwork manager of a node (2) controls the supply of power to the node (2).

14. The method as claimed in claim 12, wherein the subnetwork manager of a node (2) is configured to communicate with the subnetwork manager of other nodes (2) of the network.

15. The method as claimed in claim 11, wherein each node (2) is configured to use a wakeup command to activate adjacent nodes (2) when the adjacent nodes (2) are deactivated.

16. The method as claimed in claim 11, wherein each node (2) is configured to initiate an activation command for activating a subnetwork.

17. The method as claimed in claim 11, wherein the communication in the vehicle network (1) is Ethernet-based communication.

18. The method as claimed in claim 11, wherein if a node (2) is configured as a gateway, the gateway sets up switching between subnetworks having different network structures.

19. A node in a vehicle network (1) having a network interface and a subnetwork manager, the subnetwork manager being configured to carry out the method as claimed in claim 11.

20. A vehicle network having a plurality of nodes (2) that are interconnected via network interfaces to form the vehicle network (1), wherein each of the plurality of nodes (2) is a node (2) as claimed in claim 19.
